(19) United States
(12) Patent Application Publication
(10) Pub. No.: US 2026/0050456 A1
(43) Pub. Date: Feb. 19, 2026

(54) GENERATING NODE INTERACTIONS FOR GRAPHIC USER INTERFACE DESIGN

(71) Applicant: FIGMA, INC., San Francisco, CA (US)

(72) Inventors: Garrett MILLER, Carrboro, NC (US); Michael FELDSTEIN, San Rafael, CA (US); Luca DAMASCO, New York City, NY (US); Ricky RAJANI, New York City, NY (US); Jediah KATZ, New York, NY (US); Nikolas KLEIN, San Francisco, CA (US); Gino KNODEL, San Francisco, CA (US); Jon KAPLAN, New York, NY (US); Spencer DE MARS, Mill Valley, CA (US); Jay PILLAI, San Jose, CA (US); Dylan Castillo ABSTENGO, New York, NY (US)

(21) Appl. No.: 19/299,199

(22) Filed: Aug. 13, 2025

Related U.S. Application Data
(60) Provisional application No. 63/683,039, filed on Aug. 14, 2024.

(51) Int. Cl. G06F 9/451; G06F 3/0482; H04L 65/1089

(52) U.S. Cl. CPC G06F 9/451; G06F 3/0482; H04L 65/1089

(57) ABSTRACT

Examples include a computer system to enable one or more users to create and configure graphic user interface content for a runtime environment, where the graphic user interface content including a collection of nodes. The computing system programmatically determines connection data as between a plurality of nodes that comprise at least a portion of the graphic user interface content. Based on the connection data, the graphic user interface is rendered to include a set of interactions, where each interaction represents a corresponding runtime transition as between a begin state and an end state of a runtime environment.

### CROSS-REFERENCE TO RELATED APPLICATIONS

This application claims priority benefit of United States Provisional patent application titled “GENERATING NODE INTERACTIONS FOR GRAPHIC USER INTERFACE DESIGN,” Ser. No. 63/683,039, filed Aug. 14, 2024. The subject matter of this related application is hereby incorporated herein by reference.

### TECHNICAL FIELD

Examples described herein relate to a graphic design system, and more particularly, a graphic design system for generating node interactions for a graphic user interface design.

### BACKGROUND

Graphic design systems refer to software or computer-based applications and services that enable design users to create various types of graphic designs. Graphic design systems can have many forms and applications. One type of application is the creation of content for functional user interfaces of executable applications. In such context, a graphic design system can be used to create the various screens, features and associated content of a functional user-interface for an executable application.

In the current state of the art, graphic design systems are highly technical and computationally-intense systems that can be implemented on various types of computing environments (e.g., desktop computer, laptop, mobile device, server, etc.). Generally, such systems enable creation of graphics for a functional runtime or production environment. Graphic design systems can enable collaboration amongst users, meaning multiple users can collaborate at the same time to create and edit graphic user interface content. Additionally, a graphic design system can enable users to simulate a runtime environment where graphic user interface design content is to be implemented.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A illustrates an interactive graphic design system (IGDS), according to one or more embodiments.

FIG. 1B illustrates example processes performed for determining interactions, according to one or more embodiments.

FIG. 2A through FIG. 2C illustrate example methods for programmatically determining interactions between nodes of a graphical user-interface design content during a design phase, according to various examples.

FIG. 3A and FIG. 3B illustrate an example in which a graphic design system programmatically generates interactions, according to one or more examples.

FIG. 3C and FIG. 3D illustrate an example of an interaction edit mode, according to one or more examples.

FIG. 4 is a block diagram illustrating a computer system on which one or more embodiments can be implemented; and

FIG. 5 is a block diagram illustrating a user computing device for use with one or more examples described herein.

### DETAILED DESCRIPTION

Examples include a computer system to enable one or more users to create and configure graphic user interface content for a runtime environment, wherein the graphic user interface content including a collection of nodes. The computing system programmatically determines connection data as between a plurality of nodes that comprise at least a portion of the graphic user interface content. Based on the connection data, the graphic user interface is rendered to include a set of interactions, where each interaction represents a corresponding runtime transition as between a begin state and an end state of a runtime environment.

Examples further provide a computing environment in which a user is enabled to create and configure a graphic user interface content for a runtime environment, where the graphic user interface content including a collection of nodes, and each node of the collection including node information. In examples, input data is received from the user, where the input data identifying a portion of the graphic user interface content. In response to receiving the input data, connection data as between a set of nodes of the collection is determined, based on the node information. Based on the connection data, a set of interactions are rendered for the user, where each interaction identifies from the collection, (i) a source node that represents a begin state of a runtime transition, and (ii) a destination node that represents an end state of the runtime transition. In some examples, the interactions can be visually represented as line connectors, with arrows or other visual indicators to indicate the respective nodes that are the source and destination.

Examples described herein involve providing a graphic design system in which design users (or designers) create links between design elements that graphically represent the states of a functional user-interface of a run-time application. The graphic design system can be implemented at least in part by a browser, browser-based application, dedicated application, plugin component (e.g., such as for a browser) or similar component, executing on a user device. For example, the graphic design system can be implemented by a browser or browser-based application (collectively “browser application”) accesses a website or network service to receive and execute instructions for implementing a graphic design system on the user device. In such examples, the browser application communicates with a backend network computing system in real-time. The browser application implements the graphic design system to provide the user with the ability to create graphic aspects of a functional user interface for a runtime application (e.g., for a runtime or production environment).

In various examples, the graphic design system can be implemented to facilitate, during a design phase, the designation of runtime interactions and state changes as between interactive or dynamic design elements of a functional user interface of a run-time application.

In certain examples, the graphic design system may provide collaboration features that enable a user to collaborate with other remote users in the creation of graphic user interface design content. In various examples, each collaborator can implement an interactive graphic design system on a corresponding computing device to interact with a current workspace file that provides graphic user interface content for collaboration.

According to embodiments, a graphic design system can be implemented by an application (e.g., browser application) executing on the user device, in communication with a backend computing system, to perform examples as described herein. In some aspects, the graphic design system can implement processes to programmatically generate, or otherwise determine, logical connections between nodes (e.g., individual cards or interactive design elements of cards), in order to define dynamic and/or interactive aspects of a functional user-interface for a corresponding run-time application. In variations, a graphic design system implements or otherwise utilizes intelligent models or services to identify such logical connections. Still further, in additional examples, a graphic design system implements an AI model or service (e.g., such as may be provided through a third-party service via an API) to facilitate the determination/generation of such logical connections.

Further, in examples, an interactive graphic design system can display, on a user's computing device, graphic user interface design content. The interactive graphic design system can also provide a selectable feature to trigger the programmatic generation of logical connections between nodal elements of the graphic user interface content, where the nodal elements can include a card (e.g., representing a display screen), and design elements that represent interactive or stateful features of the runtime environment (e.g., soft-buttons, menus, menu items, text boxes, checkboxes, icons, etc.). The runtime application can include any production-environment application or program, executing on a particular OS platform (e.g., ANDROID, IOS, etc.).

To create and edit graphic user interface content, the interactive graphic design system receives input data from the user, where the input data can identify frames or other objects (e.g., top-level frames, nested frames, children frames), configurations of frames (e.g., attributes, such as line attribute, fill attribute, shape, size, etc.), and logical connections that can define runtime relationships amongst nodes. According to examples provided herein, the logical connections are automatically generated via one or more programmatic tools (e.g., classifier, heuristics, AI model or service).

In certain implementations, a designer provides input on the design through the interactive graphic design system to select and modify nodes (e.g., card, design elements of cards) of the graphic user interface content.

As used herein, “runtime” refers to a runtime environment, such as a production environment where a graphic design is coded and executed for an end user. A runtime environment is distinct from a design phase, where a graphic design is created and configured. In this context, a “runtime relationship” is intended to mean a relationship that is determined during a design phase, for implementation of the graphic design in the runtime environment. As described, the runtime environment can be simulated at the design phase, through a simulation environment.

In examples, multiple nodes in the design phase can represent a multistate feature of the runtime environment. In the design phase, an interaction between two nodes can represent a single feature in two states. The dynamic runtime transition between two nodes (source and destination) that are linked by an interaction in the design phase can also be simulated in the design phase.

Among other advantages, embodiments improve the operation of computing systems where graphic design systems are implemented and utilized. Conventional approaches allow for designers to specify runtime behaviors for a graphic user interface during its design phase. For example, designers can represent runtime transitions using line connectors that connect a pair of design elements, where the line connectors appear as part of, or with the graphic user interface content. Based on the complexity of the UI design, the number of such line connectors which may be present with the graphic user interface content can be large (e.g., hundreds, thousands or more). In a collaborative environment, multiple users may specify such line connections, and the ability of individual users to track line connectors created by other users can diminish with the complexity of the design. The computer systems where such graphic design systems are implemented can be weighted down with the creation and editing (often by multiple users) of such line connectors. In contrast to conventional approaches, embodiments provide for an interactive graphic design system that can be implemented to programmatically determine logical connections that are accurate representations of desired runtime transitions and behaviors. Further, the logical connections can be determined in group, at one time, alleviating the resources that would otherwise be expended to facilitate users in creating, editing, and updating a graphic user interface design content to specify such logical connections. Additionally, in some embodiments, the resources for programmatically logical connections that reflect desired runtime transitions and behaviors can be performed using resources that are external to the user device where the interactive graphic design system is implemented, thereby further alleviating the resources required from those computing device(s). Further, an interactive graphic design system, as described with embodiments, can also provide an interface that includes optimizations for creating and editing such line connectors, to reduce the amount of editing and resources expended with the creation of line connectors.

By providing programmatic tools for determining the logical connections, examples enable the graphic design system to be more efficiently utilized, thereby conserving resources such as browser and computing resources. Moreover, examples as described can significantly decrease development time for runtime environments that are designed through a graphic design system. Still further, examples as described enable UI designers to automate time-consuming tasks, such as the formation of line connectors to represent desired logical connections amongst nodes of graphic user interface design content.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments can be carried and/or executed. In particular, the numerous machines shown with embodiments include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer programs, or a computer-usable carrier medium capable of carrying such a program.

### System Description

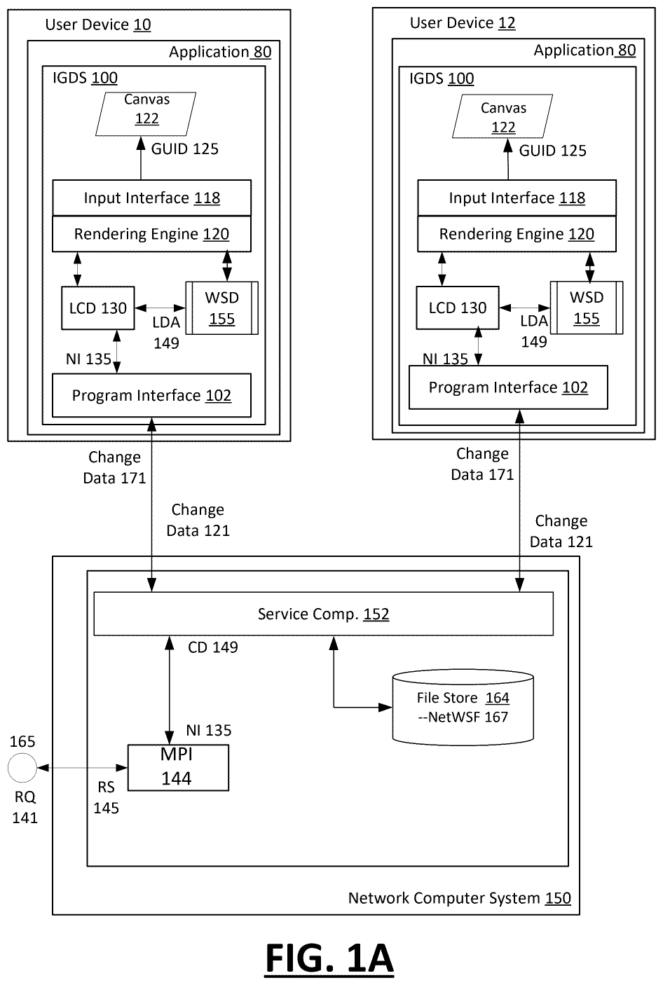

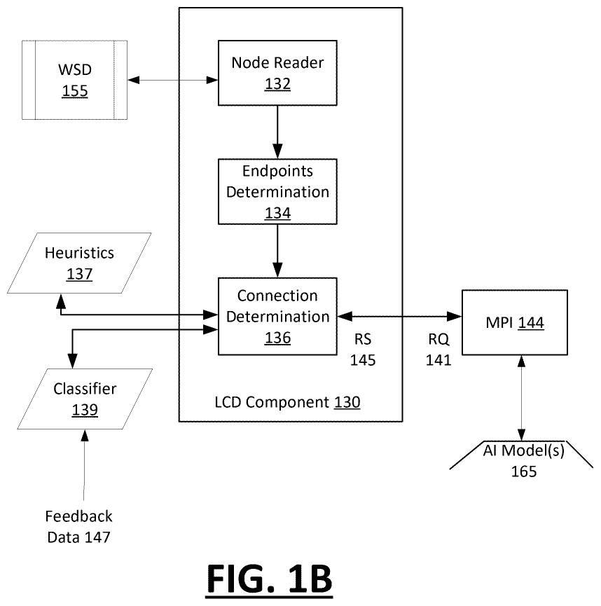

FIG. 1A illustrates an interactive graphic design system (IGDS) 100, according to one or more examples. The IGDS 100 can be implemented in any one of multiple different computing environments, including as a device-side application, as a network service, and/or as a collaborative platform. In examples, the IGDS 100 can be implemented using a web-based application 80 that executes on a web browser of a user computing device 10. In other examples, the IGDS 100 can be implemented through use of a dedicated web-based application. As an addition or alternative, one or more components of the IGDS 100 can be implemented as distributed system, such that processes described with various examples execute on both a network computer (e.g., server) and on the computing device 10.

According to examples, the IGDS 100 can be implemented on a user computing device 10 to enable a corresponding user to create, view, and/or modify various types of design interfaces using graphical elements. A design interface may include any layout of content and/or interactive elements, such as (but not limited to) a web page. The IGDS 100 can include processes that execute as or through a browser application 80 that is installed on the computing device 10.

In examples, the application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the IGDS 100 can be implemented as scripts and/or other embedded code which web-based application 80 downloads from a network site. For example, the web-based application 80 can execute code that is embedded within a webpage to implement processes of the IGDS 100. The application 80 can also execute the scripts to retrieve other scripts and programmatic resources (e.g., libraries) from the network site and/or other local or remote locations. By way of example, the application 80 may execute JAVASCRIPT embedded in an HTML resource (e.g., webpage structured in accordance with HTML 5.0 or other versions, as provided under standards published by W3C or WHATWG consortiums). In other variations, the IGDS 100 can be implemented through use of a dedicated application, such as a web-based application.

In some examples, application 80 retrieves programmatic resources for implementing the IGDS 100 from a network site. As an addition or alternative, application 80 can retrieve some or all of the programmatic resources from a local source (e.g., local memory residing with the computing device 10). Application 80 may also access various types of data sets in providing functionality such as described with the IGDS 100. The data sets can correspond to files and libraries, which can be stored remotely (e.g., on a server, in association with an account) or locally.

The IGDS 100 can be implemented as web code that executes in the application 80. This web code can include (but is not limited to) HyperText Markup Language (HTML), JavaScript, Cascading Style Sheets (CSS), other scripts, and/or other embedded code which the browser application 80 downloads from a network site. For example, the application 80 can execute web code that is embedded within a web page, causing the IGDS 100 to execute at the user computer device 10 in the browser application 80. The web code can also cause the application 80 to execute and/or retrieve other scripts and programmatic resources (e.g., libraries) from the network site and/or other local or remote locations. By way of example, the application 80 may include JavaScript embedded in an HTML resource (e.g., web page structured in accordance with HTML 5.0 or other versions, as provided under standards published by W3C or WHATWG consortiums) that is executed by the browser application 80. In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

In examples, the IGDS 100 includes processes that execute through a web-based application 80 that is installed on the computing device 10. The web-based application 80 can execute scripts, code and/or other logic to implement functionality of the IGDS 100. Additionally, in some variations, the IGDS 100 can be implemented as part of a network service, where the application 80 communicates with one or more remote computers (e.g., server used for a network service) to executes processes of the IGDS 100.

With reference to FIG. 1, the application 80 loads processes and data for providing the IGDS 100 on the computing device 10. The IGDS 100 can include a rendering engine 120 that enables users to create, edit and update workspace files for rendering graphic user interface design (“GUID”) content 125. A user of device 10 can operate the application 80 to access a network site, where programmatic resources are retrieved and executed to implement the IGDS 100. In this way, the user may initiate a session to implement the IGDS 100 to create, view, and/or modify GUID content 125. The IGDS 100 includes processes represented by program interface 102, rendering engine 120, and input interface 118. Depending on implementation, the components can execute on the user device 10, on a network system (e.g., server or combination of servers), or on the user device 10 and a network system (e.g., as a distributed process). The program interface 102 includes processes to receive and send data for implementing components of the IGDS 100. Additionally, the program interface 102 can be used to retrieve, from local or remote sources, programmatic resources and data sets which include workspace data 155 of the user or user's account. In implementation, the program interface 102 can retrieve one or more workspace files from a network computer system 150, where the retrieved workspace files include workspace data 155 which is loaded by the rendering engine 120 to generate the GUID content 125. On the network computer system, the workspace data 155 can be stored in one or more workspace files 167, stored with a file store 164 in association with an account of the user(s).

The rendering engine 120 represents processes that render GUID content 125 on a canvas (e.g., an HTML 5.0 canvas). The rendering engine 120 also includes processes that provide a framework for the GUID content 125, including an input interface 118. The rendering engine 120 can also enable users of the user devices 10, 12 to interact with the GUID content 125, via the input interface 118, in order to make changes to the GUID content 125. The rendering engine 120 renders changes to the GUID content 125 in real-time, and also updates the workspace data 155 to reflect the changes to the GUID content 125. Further, the rendering engine 120 can include processes to render additional data sets to visually represent runtime relationships, and to dynamically simulate a runtime implementation of the GUID content 125 using such additional data sets.

### Input Interface

In examples, the input interface 118 can be implemented as a functional layer of the IGDS 100. The input interface 118 can provide features for enabling a user to interact with the GUID content 125 and to specify changes to the workspace data 155. In one or more embodiments, the input interface 118 includes a user interface that can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the start and end position of an input or series of inputs (e.g., start and end position of a click and drag), and/or various other input types which the user can specify (e.g., right-click, screen-tap, etc.) through one or more input devices. In this manner, the input interface 118 can interpret, for example, a series of inputs as a design tool selection (e.g., shape selection based on location/s of input), as well as inputs to define properties (e.g., dimensions) of a selected shape.

### Workspace Data

The GUID content 125 can represent a work-in-progress for a graphic design that is implemented in a functional, runtime environment (e.g., production environment). The rendering engine 120 renders the GUID content 125 on a canvas, using workspace data 155. The users of the IGDS 100 can interact with the GUID content 125, as rendered, to update the workspace data 155. For example, users can edit the GUID content 125, by adding, changing or removing design elements, and the workspace data 155 can change to reflect the changes of the respective users. The GUID content 125 can be used to implement an interactive user-interface for a mobile application, running on a mobile platform. The IGDS 100 enables users to create the GUID content 125 during a design phase, from which a graphic design of a runtime or production environment can be deployed.

As described in more detail, the workspace data 155 from which the GUID content 125 is rendered can be comprised of a structured collection of nodes, where individual nodes are rendered as a design element (e.g., frames, images, text, etc.), having attributes (e.g., fill color, line attribute, font, etc.). The workspace data 155 can also include data that defines logical relationships for or amongst nodes during the design phase. The logical relationships can identify nodes that are parented to one another, such that design changes to one node affects another node. As another example, the logical rules may constrain the positioning of a design element (e.g., frame) during the design phase. The logical relationships can also define a runtime behavior for a production environment implementation of the GUID content 125.

In examples, the workspace data 155 can include one or more hierarchical structures which collectively represent the GUID content 125. In some examples, the hierarchical structures define a collection of layers, where each layer corresponds to an object, group of objects, or specific type of object. Further, in some examples, the hierarchical structures can represent various display screens of a functional user-interface of run-time environment. As described with examples, each display screen can be represented by a card of the GUID content 125.

In examples, the GUID content 125 can be structured as nodes, where each node represents a design element. The nodes can be arranged to have a hierarchical arrangement, where the hierarchical arrangement reflects certain relationships such as nodes that are parented to or children of other nodes. As described, the GUID content 125 can further be segmented into cards, where each card can reflect an application screen or display during run-time. In examples, the hierarchical representation includes a top-level node and sub-nodes with additional hierarchically arranged nodes. Accordingly, in examples, each card of the collection can be represented by a root node (Level 0, or top-most level node), and each design element can be represented as a sub-node of the root node. Within each root node, sub-nodes can be arranged to have different levels. A top-most sub-node of the root node (i.e., Level 1 node) can include design elements of the card that are not children of any other design elements except for the top-level frame represented by the root node. In turn, any child design element to one of the design elements represented by a top-level sub-node (Level 1) can be represented by a second level sub-node (i.e., Level 2 node) and so forth. The design-mode nodal representation can be determined for each card, and further combined for all the cards of the collection.

Further, in examples, the active workspace data 155 from which content is generated on the user devices can include data describing the set of nodes along with data describing the hierarchical structure. Within the hierarchical structure, relationships between nodes may denote an arrangement of layers, where individual layers correspond to a frame object, a group of frame objects, or a specific type of frame object. In context of such examples, nodes in the layers can represent design elements within the design interface. Each node and/or layer can also be characterized by a set of attributes that reflect the visual appearance of the corresponding design element. The attributes of each node and/or layer can be selected or manipulated by users. By way of illustration, a user can modify individual nodes and/or layers by specifying (i) a numeric value to represent a line, corner or dimensional characteristic of a frame object; (ii) a color value (e.g., which can be formatted as HEX, HSB, HSL, CSS and RGB) for a background, or for a fill, line or shading attribute of an object; (iii) a shape or type characteristic; and/or (iv) a text string attribute (e.g., text carried by the content element).

In examples, the workspace data 155 includes data that specifies logical connections between the nodes of the workspace data, including data that defines the runtime behavior of specific nodes of the GUID content 125. In examples, the logical connections can define runtime relationships amongst multiple nodes of the GUID content 125. In additional variations, the runtime relationship can specify additional runtime aspects, including a transition behavior and/or a trigger. In examples, the nodes identified with a runtime relationship can represent a runtime transition in the graphic design as implemented in the runtime environment, such as runtime changes to a dynamic or stateful feature or aspect of the graphic design. Examples of a dynamic or stateful feature or aspect of the graphic design include an application screen, a soft button, a menu or menu item, a text box, a check box, or other aspect that can be dynamic during runtime.

In context of a runtime relationship amongst nodes, a sequence identifies a beginning and end state of a runtime transition. For illustration, the runtime relationship can be specified as between two card-level nodes, to represent a runtime change in an application screen. As another example, a runtime relationship can be specified as between multiple nodes, where each node represents a state of a runtime interactive feature (e.g., soft-button). In such an example, the runtime relationship specifies a sequence as between the nodes, representing a corresponding state change of the runtime feature. The transition behavior can specify a manner in which a runtime transition occurs, and more particularly, a manner in which the end state of the runtime transition is displayed at runtime. For example, design content of the end state can replace the design content of the begin state, or the design content of the end state can overlay the design content of the begin state. The trigger can identify a type of event (e.g., type of user input) that triggers a runtime transition.

As described with some examples, the user can interact with the input interface 118 to visually define runtime relationships for the GUID content 125. The runtime relationships can be represented by, for example, line connectors (or “interactions”) that are visually present with the GUID content 125. As shown with examples, the line connectors can be interactive, to enable users to specify start and end points, representing beginning and end states of a runtime transition. Input features (e.g., tool bar) can be provided to enable a user to specify additional runtime aspects, such as the behavior of the transition and/or the trigger for the transition.

The workspace data 155 can be stored locally, in, for example, application files used for the execution of the IGDS 100. The workspace data 155 can also be retrieved from the network computer system 150. For example, when a user initiates a session on one of the user devices 10, 12, the program interface 102 can retrieve the workspace file 155 from which the GUID content 125 content is rendered.

The input interface 118 can include design tools for enabling users to specify runtime relationships amongst nodes. The design tools can include, for example, enabling users to specify runtime relationships amongst the nodes of the GUID content 125. In examples, the input interface 118 is configured to enable users to “draw” line connectors, representing runtime relationships between nodes of the workspace data 155.

### Collaborative Environment

In examples, the IGDS 100 can be implemented as part of a collaborative platform, where a graphic design can be viewed and edited by multiple users operating different computing devices at locations. As part of a collaborative platform, when a user updates the GUID content 125 and/or workspace data 155 on the computing device 10, the changes made by the user are implemented in real-time to instances of the GUID content 125 and/or workspace data 155 on the computing devices of other collaborating users. Likewise, when other collaborators make changes to the GUID content 125, the changes are reflected in real-time within the hierarchical structures. The rendering engine 120 can update the workspace data 155 and/or GUID content 125 in real-time to reflect changes to the graphic design by the collaborators.

In implementation, when the rendering engine 120 implements a change to the workspace data 155 and/or GUID content 125, corresponding change data 121 representing the change can be transmitted to the network computer system 150. The network computer system 150 includes a service component 152 that implements one or more network services for each user device 10, 12. The service component 152 can implement one or more synchronization processes to maintain a network-side representation of the workspace data 155. In response to receiving the change data 121 from the computing device 10, the service component 152 updates the network-side representation of the workspace data 155 and transmits corresponding change data 171 to user devices of other collaborators. Likewise, if another collaborator makes a change to the instance of the workspace data 155 on their respective device, corresponding change data 121 can be communicated from the collaborator device to the network computer system 150. The service component 152 updates the network-side representation of the workspace data 155 and transmits corresponding change data 171 to the user device 10 to update the hierarchical structures and the GUID content 125.

### Simulation Mode

In examples, the rendering engine 120 can be implemented in a mode that simulates a runtime environment for the GUID content 125. In the simulation mode, the rendering engine 120 renders individual cards of the GUID content 125 in a simulated runtime environment. An individual card can be rendered, for example, as an application screen. The rendering engine 120 can also identify those nodes of the rendered card that are a source node for an interaction. The identified nodes can be represented as an interactive runtime feature. When the user selects one of the source nodes in the simulation mode, the rendering engine 120 replicates a corresponding runtime transition, based on the interaction(s) associated with the selected node. For example, the selected node can change in appearance (e.g., change in fill color), based on the destination node specified by the interaction. The simulation mode can also implement a runtime transition behavior when rendering the destination node in place of the source node. For example, the destination node may be rendered in place of the source node, or as an overlay over a portion of the card that contains the source node.

### Logical Connection Determination Component

In some embodiments, the IGDS 100 includes functionality represented by a logical connection determination (“LCD”) component 130. The LCD component 130 represents processes for programmatically determining logical connections amongst nodes of the GUID content 125. As described with examples, the determined logical connections can specify a runtime behavior involving connected nodes.

The LCD component 130 processes a selection of nodes of the GUID content 125 to determine runtime relationships that may exist as between the nodes, where each runtime relationship corresponds to a beginning and end state of a runtime transition. The LCD component 130 can identify which nodes of the selection are part of a runtime transition, as well as a sequence between the identified nodes of the runtime transition. For each runtime transition, the LCD component 130 may also determine (i) a type of transition behavior that is likely to be desired for the runtime transition; and/or (ii) a type of runtime trigger that is to cause the runtime transition.

In some examples, the determinations of the LCD component 130 are communicated to the rendering engine 120, which in turn generates a visual representation of the logical connections. The visual representation can be in the form of line connectors, termed “interactions”, to represent a runtime transition. A user can interact with the interactions to change a corresponding runtime relationship. For example, a user can interact with a line connector, representing an interaction, to change the start node, end node, transition behavior and/or trigger for the determined runtime transition. The user can also remove the interaction altogether, such that the corresponding runtime relationship is not provided for in the GUID content 125. Add new interactions.

In examples, the determined logical connections correspond to runtime transitions that identify a start node, an end node, a runtime behavior, and/or a trigger for the runtime transition to occur. As an addition or variation, the LCD component 130 can also identify, for the determined connections, a transition behavior for identified runtime transitions. The transition behavior can identify the manner in which an end state of the runtime application (as represented by a destination node) is to be transitioned to from the begin state (as represented by a source node). The trigger type identifies an input type (e.g., “on-click”, hover, etc.), event or condition under which the runtime transition between the specified nodes is to take place.

In examples, the input interface 118 receives user input associated with a select portion of the GUID content 125. For example, the input interface 118 can receive a pointer click and drag selection that identifies several cards or other nodes of the GUID content 125. Alternatively, the user can use the input interface 118 to select a section that includes multiple cards. Still further, the user can specify individual nodes (e.g., representing buttons or other interactive runtime features). In some examples, upon input interface 118 can also include a trigger feature for enabling the user to initiate a process to automatically determine logical connections amongst nodes, including interactions that represent runtime transitions.

In response to a user selecting a segment of the GUID content 125, the LCD component 130 scans the workspace data 155 to identify the nodes contained in the selected segment. For identified nodes of the GUID content 125, the LCD component 130 determines nodal information 135, which can include (i) a node identifier or name; (ii) text attributes of the node, including the position and size of text content included with the node; (iii) hierarchical or other logical relationships which may exist with other nodes; (iv) other attributes of the node, such as frame attributes (e.g., type of frame, size, line or fill attribute, etc.), and/or (v) relative position of the nodes of the selected segment of the GUID content 125.

In examples, the LCD component 130 includes and/or has access to (e.g., via an application programming interface (API) and/or another type of interface) a large language model (LLM), generative model, and/or machine learning models (collectively “AI model(s) 165”), where the model(s) 165 are capable of using programmatic/text-based descriptions of the selected GUID content 125 to determine logical connections amongst nodes of the GUID content 125, where the determined logical connections identify nodes of the GUID content 125 which represent runtime behaviors (e.g., transitions) a corresponding application. In some examples, the AI models 165 are provided as an internal service or feature available with the IGDS 100 and/or network service provided by the network computer system 150. In variations, the AI models 165 can include, or correspond to an external or third-party LLM service that is accessible through an application program interface (API) provided with the IGDS 100 and/or network computer system 150.

As an addition or variation, the LCD component 130 can utilize heuristics and/or machine learned classifiers to determine connection data for a selection portion of GUID content 125.

The LCD component 130 can communicate with, or include, processes represented by a model program interface (“MPI”) 144 to interface with the AI models 165. In some examples, the MPI 144 generates structured prompts for interacting with the AI model 165. The structured prompts can include nodal information 135. As an addition or variation, the structured prompts can include labels that identify relevant information for the AI model 165. For example, the LCD component 130 can use heuristics and/or predictive models to determine end points for interactions, determined interactions, and/or likely or predicted connections (or interactions) for the determined end points of the nodal information. These determinations can be used as labels to improve the performance of the AI model 165.

In examples, the MPI 144 converts the nodal information 135 into JSON or other programmatic format. The LCD component 130 communicates, via the MPI 144, a request 141 to the AI model 165, where the request includes programmatic input (e.g., JSON file), including structured prompts and/or additional information, to cause the AI model 165 to determine logical connections (e.g., to represent interactions) amongst select nodes of the GUID content 125. The request 141 can be communicated to the AI model 165 via the MPI 144, to receive a model response 145. The model response 145 can include connection data that identifies model-suggested connections amongst the identified nodes.

In examples, the LCD component 130 receives the model response 145 from the AI model 165. The model response 145 can include connection data 149 that identifies a set of interactions for the nodes of the selected segment. The LCD component 130 can receive and process the model response 145 to identify interactions amongst the nodes of the workspace data 155. The LCD component 130 can include processes that analyze the connection data 149 of the model response 145 to determine whether model-suggested connections (or interactions) are valid or invalid. The determination can be based on, for example, a heuristic rule set to evaluate each of the connections indicated in the model response 145. For example, the heuristic rule set can include rules which the logical connections indicated with the connection data should not violate. In some examples, if the determination is deemed invalid, the LCD component 130 can determine a correction that would make the connection valid (e.g., change source node). Additionally, the determined connections 149 can be rendered by the rendering engine 120 as interactions, displayed as, for example, line connectors. As described, a designer can interact with the GUID content 125 to validate, not validate, edit, and/or delete the determined interactions, as well as to add new interactions.

In examples, the request 141 to the AI model 165 can also include prompts to have the AI model 165 identify runtime behaviors and/or triggers for causing the runtime behavior. In some examples, the prompts generated for the AI model 165 can include logic and rules for enabling determination of runtime behaviors or triggers amongst connections. As an addition or variation, the LCD component 130 can determine runtime behaviors and/or triggers amongst connections identified in the model response 145. For example, the LCD component 130 can determine runtime behaviors and triggers as a post-processing step when the model response 145 is received.

In examples, the LCD component 130 can also utilize a set of heuristic data to identify a candidate (or recommended) set of interactions, based on connection data included in the model response 145. The LCD component 130 can also apply heuristics to automatically configure (or reconfigure) the interactions indicated by model response 145. For example, the LCD component 130 can include logic to scan a determined interaction, and to make a determination as to whether the interaction is valid. As an addition or variation, the LCD component 130 can also include logic to automatically edit an interaction that is deemed invalid for violating a rule so that the interaction is valid, by, for example, changing one of the nodes identified in the connected pair.

While an example of FIG. 1A illustrates the MPI 144 as a server-side component, in variations, the MPI 144 can be integrated by the LCD component 130, and implemented in whole or in part on the user device 10, 12. In other variations, the LCD component 130 can be implemented in whole or in part on the network computer system 150.

In response to performing the processes as described, the LCD component 130 programmatically determines connection data 149, representing interactions, for a selected segment of the GUID content 125. The LCD component 130 updates the workspace data 155 to identify the determined interactions, with each interaction specifying a source node and destination node. Additional information about individual interactions can also be determined and stored with the workspace data 155. For individual interactions, the information can also include (i) data identifying a runtime transition behavior for the interaction, and/or (ii) a trigger (e.g., type of user input) that can cause a runtime transition as indicated by the identified source and destination nodes.

### Interaction Determination

FIG. 1B illustrates example processes performed by the logical connection determination component 130 of FIG. 1A. As shown, the LCD component 130 includes process(es) represented by node reader 132, endpoint determination 134 and connection determination 136. The processes described with the LCD component 130 can be implemented in whole or in part on a given user device 10, 12, and/or by the network computing system 150, which may utilize a network side version of the workspace data 155. In examples as described, the LCD component 130 implements processes to determine logical connections that include interactions, where each interaction is a connection between two or more nodes that represent a runtime transition. Each determined interaction can include a source node, representing a begin state of the transition, and a destination node, representing an end state of the transition.

With reference to FIG. 1B, the node reader 132 scans the workspace data 155 to identify nodal information 135 that can include (i) a node identifier or name; (ii) text attributes of the node, including the position and size of text content included with the node; (iii) hierarchical or other logical relationships which may exist with other nodes; (iv) other attributes of the node, such as frame attributes (e.g., type of frame, size, line or fill attribute, etc.), and/or (v) relative position of the nodes of the selected segment of the GUID content 125.

The endpoint determination 134 processes the nodal information 135 to determine nodes that are likely end points (i.e., source node and destination node) for an interaction. The identification of end point nodes can be performed before, or independent of a determination of what nodes are logically connected as an interaction. Rather, the identification of end point nodes can be to identify nodes that have a particular set of characteristics. By way of example, end point nodes can include (i) nodes that are top level nodes, and (ii) nodes that have the visual characteristics or context of an interactive runtime feature. In the latter, the visual characteristics can include a shape of a frame, such as whether an outer node of a particular node is a rectangular, oval or round frame, reflecting a soft button or icon. In variations, a similarity analysis can be performed to determine whether a particular node is visually similar to known endpoints (e.g., soft button, etc.). The endpoint determination 134 can also inspect nodes for text attributes, such as designated terms or keywords (e.g., “start”, “pay”, “order”, etc.) that are associated with dynamic or interactive features of a runtime environment. The context analysis can include determining whether there are multiple nodes that share a common appearance, so as to reflect a runtime state change, or series of changes.

For each node, the determination of whether the particular node is an end point node can also be based on the hierarchical level of the node (e.g., Level n nodes are more likely to be an interactive element). The endpoint determination 134 can also utilize characteristics of a container or parent node. Still further, the context analysis can include pattern analysis, reflecting the occurrence of a recognizable runtime interaction event (e.g., selection of a soft button, causing change in appearance to the soft button, selection of a menu or menu item, etc.). The nodal information 135 can be analyze for nodes that contain visual attributes reflecting a particular state of a predetermined pattern. By way of example, multiple nodes (e.g., cards) can be identified as pertaining to the same application screen, in which case the sub-nodes of each card can be analyzed for variances reflecting the presence of dynamic or interactive features. Nodes that represent variances amongst one another on a card or other top level node can be determined at being end points, or more likely identified as such. The endpoint determination 134 can use a dictionary of recognizable patterns in determining interactive runtime nodes are present.

As an addition or variation, the identification of end point nodes can include identifying nodes of a particular type, such as nodes that are designed to represent a feature for receiving a particular type of input (e.g., checkbox, text entry box, etc.). Additionally, the workspace data 155 can identify multiple nodes as being a variant of a component, and each node of the component can be identified as an end point.

In this way, some examples provide for the use of rules and heuristics to determine runtime end points. In variations, the runtime end points can be determined through probability analysis, such as through use of predictive models (e.g., machine-learned) or artificial intelligence.

In examples, the connection determination 136 evaluates each possible node pairing amongst determined end points to determine whether an interaction should likely exist for the node pair. Each determined interaction can identify a node pairing, including a source node and a destination node, from the end point nodes. Thus, each determined node pair identifies the nodes of the interaction, as well as the sequence represented by the interaction.

In some examples, the connection determination 136 utilizes heuristics 137 to identify interactions amongst the identified and point nodes. The heuristics 137 can include predetermined rules and logic that identify interactions based on node characteristics or features, including the hierarchical arrangement of the node and/or visual attributes of the node (e.g., frame shape, contents of frame, text associated with frame). In some examples, the heuristics can be based on account settings or preferences (e.g., a definition of end points associated with an account), as well as historical information.

As an addition or variation, the connection determination 136 can use one or more classifiers 139 to determine likely node pairings of an interaction amongst the identified nodes of the user selection. The classifier 139 can correspond to a boosting classifier, such as provided by an XGBoost model, trained to predict interactions amongst the node pairs. In examples, the classifier 139 can be based on data sets where known interactions can be observed, such as simulations run on graphic designs of different types. The classifier 139 can also be trained on the heuristics, including heuristics that are specific to features of nodes. Further, interactions that are created by a user with respect to the GUID content 125, or other workspace files/data, can also be used to train the classifier 139.

The classifier 139 can also be trained on subsequent user input (termed “feedback data 147”) where the programmatically determined interactions are confirmed, modified or deleted by the user. For example, the rendering engine 120 can provide a feedback interface with rendered interactions (e.g., such as with the interaction editing mode, described in examples below), to enable a user to provide direct feedback for individual interactions, where the feedback indicates the interaction is valid or not valid. As an addition or variation, the input a user provides when reviewing interactions, such as input to delete or modify interactions, can be recorded and used as feedback data 147.

As an addition or variation, the connection determination 136 can utilize one or more AI models 165 to determine likely node pairings amongst the identified nodes of the user selection. The prompts can also include labels for at least some of the nodes, where the labels designate a source node, destination node, and/or logical connection between an identified source and destination node. Such labels may be determined by, for example, the heuristic 137, the classifier 139, and/or through user input. By including labels, the performance of the AI model 165 can be improved. The connection determination 136 can include processes to determine a programmatic input (e.g., JSON file) for an AI model 165. The programmatic input can include specific prompts as to what the AI model 165 is to return, as well as information that specifies clues, weights, labels (e.g., heuristic based determination of node pairings, etc.). The request 141 can also specify end point nodes, so that only those nodes that can be a basis for a connection or interaction are identified in the request 141. The request 141 can be communicated to the AI model 165 using the MPI 144. While the MPI is shown as a separate component, in variations, the MPI 144 can be integrated with the LCD component 130.

The LCD component 130 can process the model response 145 to identify connection data, indicating programmatically-determined interactions in the selection of nodes. The connection data of the model response 145 can be subjected to additional analysis to determine whether each of the identified connections are valid or not. If not valid, the LCD component 130 can include additional processes to edit the programmatically-determined connection data, so that is the identified interaction is valid (e.g., change end node).

In addition to identifying node pairings, for each determined pairing, examples provide that the runtime transition behavior can also be determined. The runtime transition behavior can reflect the manner in which the end state of a runtime transition, as represented by the destination node, is displayed with respect to a begin state of the runtime transition, as represented by the source node. The runtime transition behavior can correspond to a predefined visual effect. For example, the runtime transition behavior can correspond to a setting or designation that reflects one of (i) a content of the end state (represented by the destination node) replaces the content of the begin state (represented by the source node); and (ii) the content of the end state overlays the content of the begin state. The LCD component 130 can use, for example, heuristics 137, classifier 139, and/or AI model 165 to determine the runtime behavior that is to be associated with a connection.

As an addition or variation, for each determined interaction, a runtime trigger can also be determined. For example, by default, the runtime trigger correspond to an “on-click” event, corresponding to an end user of the production environment clicking or otherwise selecting a feature represented by a source node. In variations, additional runtime triggers can be determined, such as corresponding to a hover event, or an end user of the production environment covers a cursor over the feature represented by the source node. For example, the LCD component 130 can use heuristics 137, classifier 139, and/or AI model 165 to determine runtime trigger that is to be associated with a connection.

The processes of the LCD component 130 generate connection data 149 that can be rendered as interactions. The LCD component 130 updates the workspace data 155 for the GUID content 125. The rendering engine 120 uses the connection data 149 to render interactions amongst the nodes of the GUID content 125. Additionally, the rendering engine 120 can selectively render (e.g., in an interaction rendering mode) individual endpoints, as determined by the endpoint determination 134, as a single unit, to facilitate the user in selecting endpoints for creating and/or editing determined interactions.

While some examples provide for use of nodal information 135 in determining connection data for interactions, as an addition or variation, the LCD component can use image data captured for the GUID content 125 (or portion thereof). For example, the LCD component 130 can capture one or more thumbnails of individual nodes and/or select portions of the GUID content for analysis. The image data can be processed using, for example, AI model 165, an image classifier (e.g., using an image similarity model), and/or heuristics to determine connection data for interactions. The image portions of the nodal information 135 can be analyzed using a machine-learned classifier, such as a boosting classifier. Still further, in examples, machine-learned processes can include one or more types of classifiers (e.g., image classifier, text classifier) to analyze text and/or image portions of the nodal information 135 in order to predict, or make initial determinations of the endpoints for interactions. The endpoint predictions can identify individual nodes as source and/or destination nodes for individual interactions. The training for such models can be performed using publicly available (or third-party) information (e.g., published simulations and prototypes) as well as account or user-specific information (e.g., simulations or prototypes of the user or the account).

### Interaction Rendering Mode

In examples, the rendering engine 120 implements an interaction editing mode for the GUID content 125, where the interaction rendering mode includes optimizations to facilitate a user in viewing, editing, deleting and/or creating interactions. In the interaction editing mode, the GUID content 125 can be initially rendered without interactions.

According to an aspect, when the GUID content 125 is displayed in the interaction editing mode, the rendering engine 120 displays nodes that are deemed to be interaction endpoints as a single unit, such that sub-nodes or design elements contained (or parented) within those nodes are not selectable. By rendering the interaction endpoint nodes as a single unit, the respective node can be made easier to select by a design user, thereby enabling the design user to specify a line connection to a destination node (representing an interaction).

The input interface 118 can provide an interaction trigger that when selected, triggers an automated, programmatic process for determining interactions. The interactions can be determined for a select portion of the GUID content 125, based on design user input. The rendering engine 120 can draw interactions as between pairs of nodes, where the interactions are determined from the connection data 149, implementing processes to determine node pairings and other aspects of interactions.

In examples, the interaction editing mode enables a design user to traverse individual interactions in order to edit (e.g., change source or destination node, change runtime transition behavior, etc.) or delete the determined interactions. The user can also use the interaction editing mode to create interactions. Further, in the interaction editing mode, the user can provide feedback data 149 regarding the validity of programmatically determined interactions, in order to tune or train the classifier(s) 139 used by the LCD component 130.

### Methodology

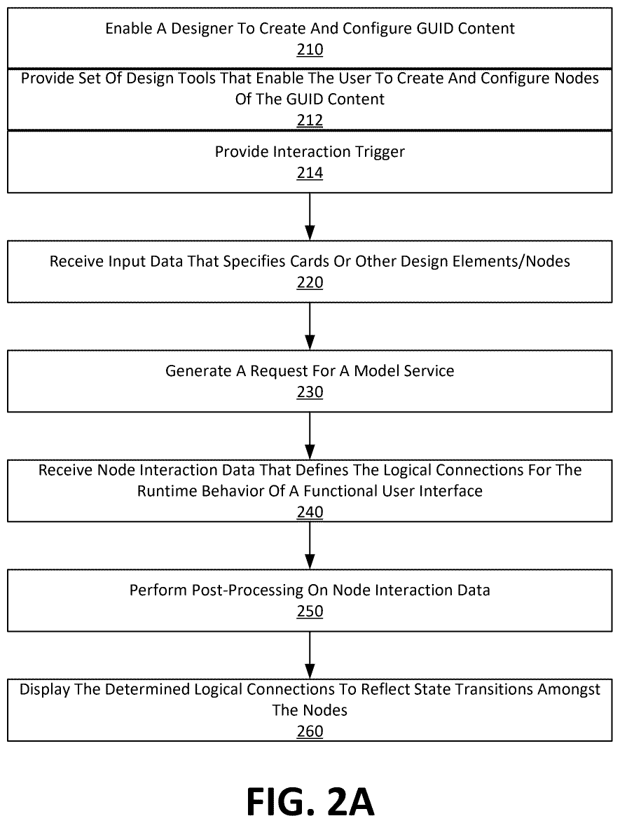

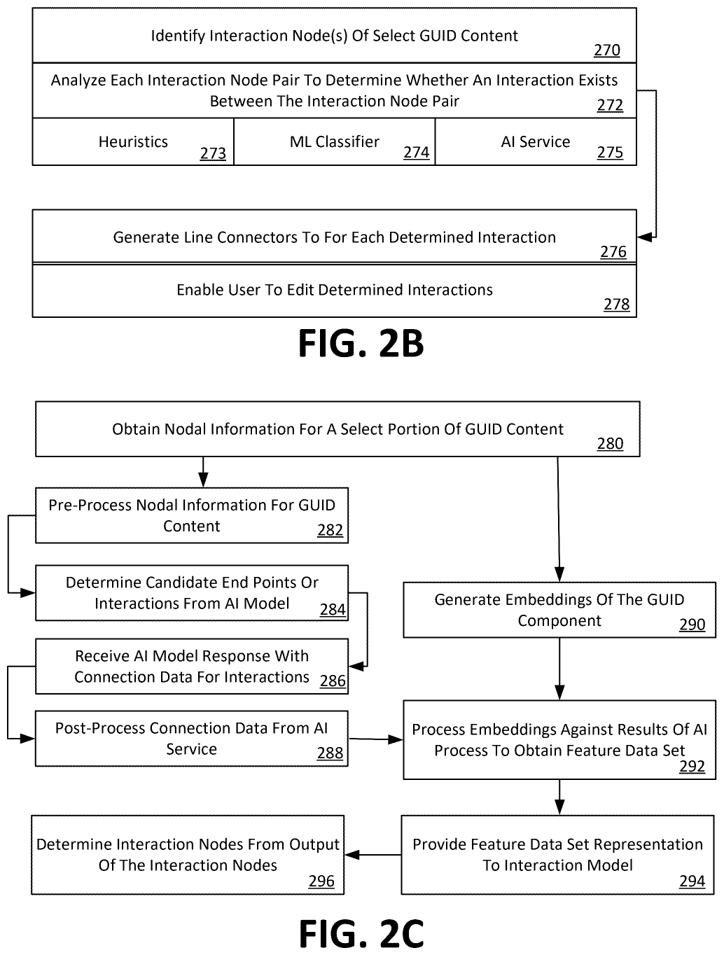

FIG. 2A through FIG. 2C illustrate example methods for programmatically determining interactions between nodes of a GUID content during a design phase, according to various examples. In the examples of FIG. 2A through FIG. 2C, reference is made to elements of FIG. 1A and FIG. 1B for purpose of illustrating suitable functionality for performing a step or sub-step being described.

Referring to FIG. 2A, the IGDS 100 provides a framework to enable a designer to create and configure GUID content 125, where the GUID content 125 comprises a collection of nodes (210). As described herein, the GUID content 125 can include any number of cards, frames and other objects that combine to specify a functional user-interface for a program or application at runtime (e.g., for a website or mobile device application executing in a production environment). The framework can include a set of design tools that enables the user to create and configure nodes for the GUID content 125, including frames (e.g., top-level frames, nested frames, children frames, etc.) and cards (212). According to examples described herein, the framework can also include an interaction trigger that triggers a process to automatically determine logical connections amongst the nodes, where the logical connections define the runtime behavior of the nodes (214).

In certain examples, the user device 10 can receive input data that specifies a segment of the GUID content 125 from which logical connections are to be automatically created (220). For example, the input data can reflect the user selecting a plurality of cards of the GUID content 125, and then selecting the logical connection trigger. In an example, a user can interact with the GUID content 125 to select a collection of cards. In a variation, the user can select a predefined section that comprises one or multiple cards. Still further, the user can select nodes individually for the determination.

Based on the input data, the IGDS 100 generates a request 141 for one or more model services (230). The model service can include an internal or external service that provides an AI model. As an addition or variation, the internal or external service can include machine-learned classifiers and processes for enabling determinations as described. For an AI model, the request 141 can be generated with AI prompt(s) that include specific parameters of the selected nodes, as well as parameters that configure the determinations of the AI model, to cause the AI model to automatically make determinations of logical connections (e.g., interactions) between nodes of the selected cards. The AI model 165 can be provided as a local resource of the network computing system 150. Alternatively, the AI model 165 can be an external resource, such as may be provided by a third-party, and the request communicated to the AI service can originate from the user device 10, 12 or the network computing system 150.

As described above, the AI prompt(s) for the selected segment of the GUID content 125 can include programmatic text representations (e.g., JSX or JSON representations) of the nodes that comprise the GUID content 125. The programmatic text representation of each node can specify a node identifier or name, a size/position of a text attribute of the node, a text content of the node, and any child nodes of the node. The AI model can process the various parameters of the AI prompt to automatically determine connection data, representing runtime behavior, between the nodes of the selected segment of the GUID content 125.

In various examples, the IGDS 100 receives the connection data that defines the logical connections (e.g., interactions) for the runtime behavior of a functional user interface (240). The connection data can identify source and destination nodes of the GUID content 125 that specify a runtime transition. In some examples, the connection data is received by the network computing system 150, where post-processing is initiated or performed. Alternatively, the post-processing of the connection data is performed on the user device (e.g., via the web-based application).

In examples, the IGDS 100 can perform post-processing on the node interaction data by applying a set of heuristics (250). The post-processing can determine whether the logical connections are valid, and if invalid, in some variations, the post-processing can modify the logical connections to make them valid or otherwise optimized for the runtime environment. Accordingly, in examples, the node interaction data returned from the model service can identify candidate interactions, which can be subject to the post-processing for validation.

In some examples, the IGDS 100 can display the determined logical connections (e.g., interactions) to reflect state transitions amongst the nodes (260). The logical connections can be displayed as line connectors (e.g., “interactions” as described with other example). The user can interact with the visual representation of the logical connections, by selecting, for example, a respective line connector. For example, through direct interaction with a displayed interaction, the user can provide input to modify or remove the interaction. In this way, the logical connections can be reviewed by design users for attributes such as the type of interaction specified with the logical connection, the transition behavior resulting from the interaction, and/or other attributes of the logical connection. The user can use a framework of the IGDS 100 to define the interactions, make edits, and/or accept or decline individual interactions reflected by the line connectors.

With reference to FIG. 2B, the LCD component 130 includes processes that execute to make one or multiple determinations related to the presence of interactions for a select portion of the GUID content (270). As mentioned, in the design phase, two or more nodes of the GUID content 125 can be visually connected by a line connector, termed an “interaction”, to represent a runtime transition that occurs where a begin state of a transition is represented by a source node of the interaction, and the end state of the transition is represented by an end node of the interaction. The select portion of the GUID content can be a broad selection that is not specific to a particular node. For example, a method such as described with an example of FIG. 2B can be implemented in response to a selection where a user selects a card, a collection of cards, or other segment of a workspace file from which one or multiple interaction nodes are identified. In other examples, the selection portion of the GUID content can correspond to a narrow selection, where a specific node is identified.

When the selected portion of the GUID content includes multiple nodes, the LCD component 130 processes the scene graph of the select GUID content to identify those nodes that are likely interaction nodes, meaning a node that likely represents a begin state or end state of a runtime transition. Interaction nodes can correspond to, for example, a card, or a node that represents an interactive element of a card, such as a soft button, icon, menu feature, etc. Each node that is likely an interaction node can be identified for a scene graph representation of the GUID content 125. In examples, the LCD component 130 analyzes each possible node pair to determine whether an interaction exists (or is likely to exist) between the node pairs (272). Further, if an interaction is determined to exist between an identified node pair, the LCD component 130 can make a determination of the likely transition sequence between the identified node pairs.

In variations, the determinations made relating to interaction nodes can include identifying, from the selected portion, each interaction node (or candidate node), and further determining whether the interaction node is a source or destination node for the interaction. Once a node is determined as a source or destination, a likely pairing is determined, based in part on the nodal information of the respective pair nodes.

Still further, in examples, the selected portion of GUID content can identify a specific node. In response, the LCD component 130 determines a node pair for a likely interaction that is based on the specific node. In some examples, a user input can specify a given node, and the LCD component 130 makes determinations that include identifying a destination node, under an assumption that the specified node is a source node. In other variations, the LCD component 130 makes an initial determination as to whether the specified node is a source node or a destination node, and then determines the paired node for the interaction based on the initial determination.

In some examples, the determinations made for the selected portion of the GUID content can be made through use of heuristics (273), including predetermined rules and logic that identify interactions based on node characteristics. By way of example, the heuristics can include a rule where a frame for a soft button that includes a given graphic (e.g., forward arrow) is paired as a source node to another frame that includes a complementary graphic (e.g., backward graphic). As another example, the heuristics can include another rule where button frames are paired based on the buttons being part of a component set, or buttons sharing physical attributes but for one or two features (e.g., fill shading or color, size).

As an addition or variation, the determination can be made based at least in part on the use of machined-learned processes, such as a classifier within an ensemble of classifiers (274). For example, one or more classifiers can be used to determine whether individual nodes of the scene graph are characteristic of an interaction node, such as a start node for a runtime transition. As another addition or variation, the determination can be made based on an AI model or service (275), such as described with FIG. 2A.

The LCD component 130 generates a line connector for each determined interaction (276). Additionally, the rendering engine 120 renders the determined line connections for the GUID content 125 in an interaction view mode (278). The interaction view mode can be optimized for the user to view and edit interactions. When the LCD component 130 generates interactions for nodes of the GUID content, the user can toggle from a default design mode to the interaction edit mode to view programmatically determined line connections. The interaction edit mode can optimize for the user to select and edit (or delete) interactions, we well as to create new interactions. Accordingly, the ability of the user to interact with the GUID content 125 may be limited. For example, the user's inputs may be limited to viewing, editing, deleting, or creating line connections representing runtime relationships between the nodes. While each interaction may identify a corresponding source and destination node (representing a begin and end state for a runtime transition), in the interaction edit mode, the ability of the user to select or interact with sub-elements of interaction nodes may be precluded. Rather, in the interaction edit mode, a user input can be received and directed to the interaction node, rather than to sub-elements, which can correspond to, for example, a soft button or feature. However, in the default or design mode, the user can edit sub-elements of interaction nodes. Accordingly, the user may toggle back to the default or design mode to provide a full range of edits to the GUID content.

With reference to FIG. 2C, in step 280, the LCD component 130 obtains nodal information 135 for a select portion of GUI the content. The nodal information 135 can be determined in response to user input that identifies, for example, a broad selection, such as a card, collection of cards or other segment of the workspace file. Alternatively, the user input can be specific to a particular node, in which case the nodal information 135 may be specific to the selected node. As described with other examples, the nodal information 135 can include (i) a node identifier or name; (ii) text attributes of the node, including the position and size of text content included with the node; (iii) hierarchical or other logical relationships which may exist with other nodes; (iv) other attributes of the node, such as frame attributes (e.g., type of frame, size, line or fill attribute, etc.), and/or (v) relative position of the nodes of the selected segment of the GUID content 125. As an addition or variation, the nodal information 135 can include image data, such as one or more thumbnails correspond to the selected portion of the GUID (or individual nodes thereof).

In step 282, the selected portion of the GUID content is pre-processed to configure the data set for use with the AI model 165 or service. The preprocessing described can be configured to optimize an output of an AI model or service, where the output identifies likely or candidate endpoints and interactions. A candidate endpoint can reflect a node that is a likely endpoint for an interaction, or alternatively, a node that has a set of characteristics for an interaction endpoint. By way of example, candidate endpoints can include frames that are shaped like icons, soft-buttons, menus, menu items, or other types of interactive runtime elements. The preprocessing can include heuristics to generate labels, where labels identify, for example, whether individual nodes are likely an endpoint of an interaction, and/or a source or destination node for an interaction. The heuristics can include logic that identifies characteristics of nodes as indicating a node as being a source, destination, or more generally an endpoint for an interaction. For example, if a node is shaped like a soft-button and includes an arrow or other characteristic, the heuristics can identify the node as an endpoint for an interaction. The determination can be associated as a label or weight with the respective node.

As an addition or variation, the preprocessing can include using an image and text embedding model to determine labels for select nodes. The models can utilize text and/or image data of corresponding nodal information to make a determination as to whether a given node is a source, destination or endpoint for an interaction, and the determination can be associated as a label or weight with the respective node.

As described, the preprocessing process(es) can generate labels and/or weights that improve the results generated from the AI model 165. The AI model 165 can be used to generate connection data that utilizes the labels or weights in order to improve its determination. As an addition or variation, the AI model 165 can be used to identify endpoints that were not confidentially determined through the preprocesses.

In step 284, the AI model 165 or service is used to determine a set of interactions based on the candidate endpoints. The determination of labels can optimize an output of the AI model 165 or service. Further, the preprocessing can be used to derive instructions or guidance for the AI model 165. As an addition or variation, the AI model 165 can be used to determine which node of a pair of endpoints is the source and which is the destination, to reflect a corresponding runtime transition. Stull further, the AI model 165 can be used to identify a destination node for an identified source node of an interaction. Likewise, in variations, the the AI model 165 can be used to identify a source node for an identified destination node of an interaction.

In step 286, the LCD component 130 receives a model response 145 from the AI model, where the response includes connection data that represents candidate interactions. Each candidate transaction can identify a source and destination node from a select portion of the GUID content.

In step 288, connection data representing the candidate interactions is subject to post-processing. The post-processing can be performed using heuristics, from which invalid interactions can be identified in the response. In some variations, the post-processing can include logic that modifies invalid interactions so that they are valid. For example, one of the source or destination nodes of an invalid interaction can be swapped or modified so that the interaction is deemed valid.

In step 290, the LCD component 130 generates embeddings for the select portion of the GUID content, based on the nodal information 135. The embeddings can provide numerical representations of the nodes contained in the GUID content. Different techniques can be used to generate the numerical representations of the nodal information 135. The LCD component 130 can use, for example, variations of a Contrastive Language-Image Pretraining (“CLIP”) process to generate embeddings for image and/or text portions of the nodal information 135. For example, thumbnail(s) of a select portion of the GUID content can be processed through a CLIP model to generate a vector representation of the nodes. As an addition or variation, textual information for nodes of the select portion of the GUID content can be processed through another CLIP model to generate vector representations of the nodes. To classify individual nodes, the vector representation of individual nodes (as determined through CLIP models) can be compared to sample sets reflecting endpoints, source nodes and/or destination nodes, and based on the comparisons, the LCD component 130 can label the respective nodes as an endpoint, source node, or destination node for an interaction. In some examples, the vector representations (or embeddings) can be used to match nodes of the select portion of the GUID content to templates and/or one another, in order to determine nodes as source, destination or endpoint. In this way, embeddings can be used to label individual nodes as endpoint, source or destination.

Still further, in additional examples, the LCD component 130 determines embeddings for individual nodes of the selected portion of the GUID content, and then supplements the nodal information 135 for each node with the respective embedding. For example, embeddings can be generated for individual nodes, and each embedding can comprise an additional node field that characterizes the respective node.

In variations, the LCD component 130 can utilize techniques, such as BERT, t-Distributed Stochastic Neighbor Embedding (t-SNE), principal component analysis (PCA), single value decomposition (SVD), global vectors for word representations (GloVe) to generate and/or analyze embeddings based on nodal information 135. Separate embedding processes can be used to for transforming image portions of the nodal information 135 (depicting the nodes). Image embeddings can be generated by, for example, convolutional neural networks (CNN) or other processes trained on image data.

In step 292, the embeddings are processed against the results of the AI model 146 to obtain feature data set. The results of the AI model 165 can be used to generate or enhance a feature data set representation of the nodes of the selected portion. The feature data set can include, for example, labels and/or feature vectors to represent the individual nodes of the select segment. The feature data set can also identify candidate interactions or pairings as between nodes, as determined by the AI model 146.

In step 294, the feature data set representation can be provided as input to an interaction model to identify node pairings representing runtime transitions. The interaction model can be trained using simulation data, such as for publicly available simulations, and/or account-specific simulations.

In step 296, the LCD component 130 uses the output of the interaction model to determine the interaction nodes. The rendering engine 120 can then generate line connectors or provide other visual representations of interaction nodes on a review panel.

### Example GUID Content

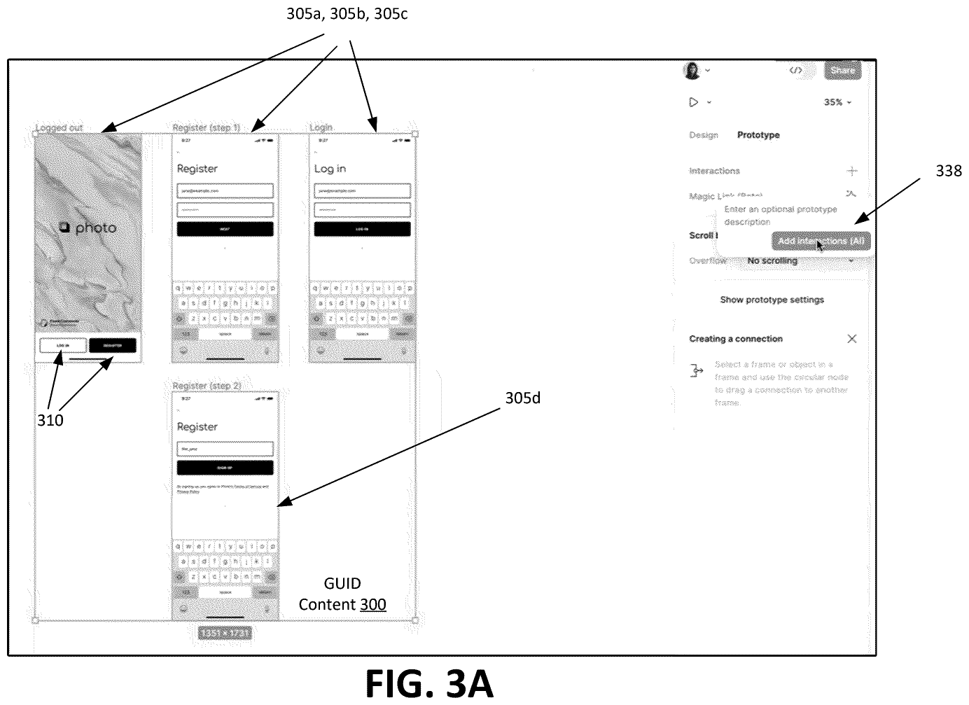

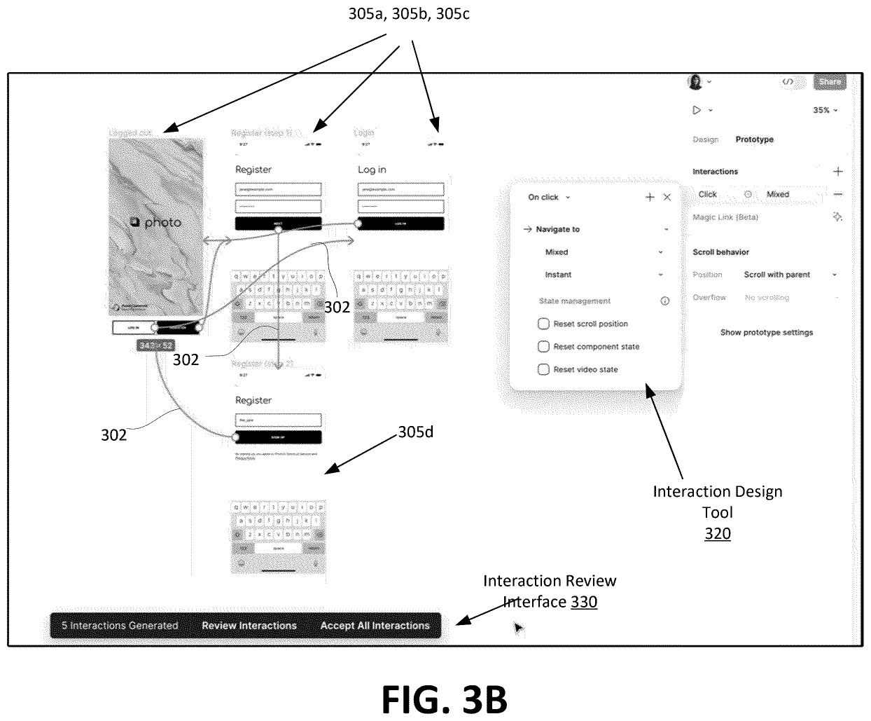

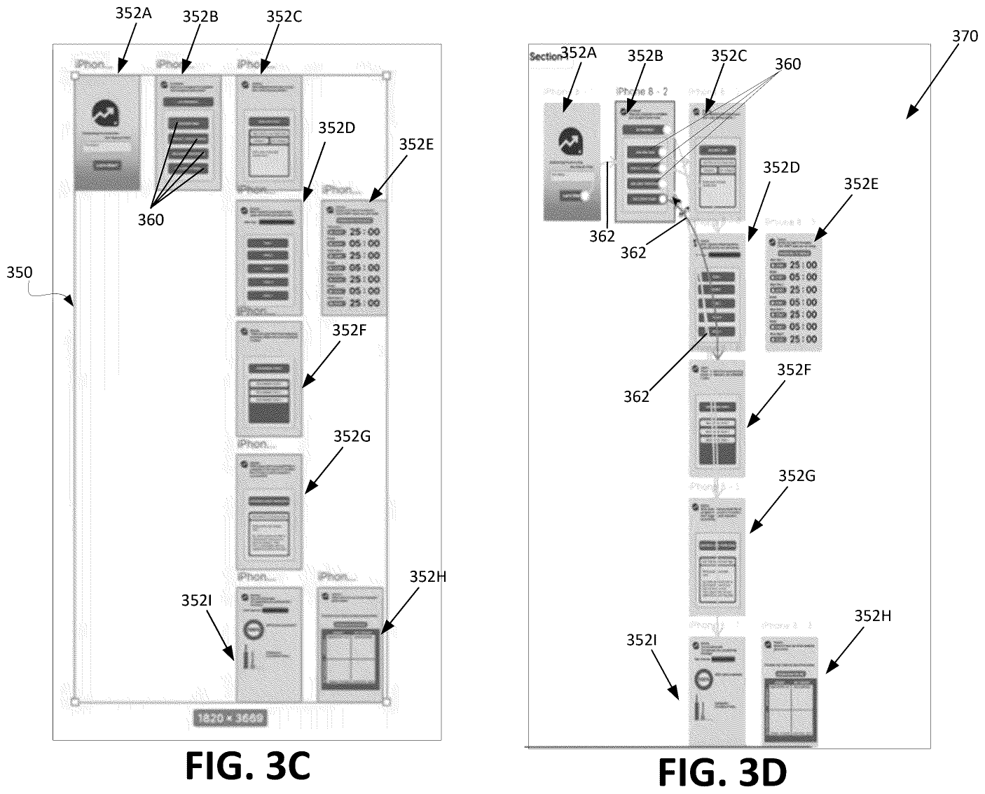

FIG. 3A and FIG. 3B illustrate an example in which a graphic design system programmatically generates interactions, according to one or more examples. With reference to FIG. 3A, GUID content 300 includes a set of multiple cards 305, where each card represents top nodes with a collection of sub-nodes (i.e., child nodes). Each node of the GUID content 300 can be associated with a name, function and set of properties (e.g., text position, size and other attributes).

In an example of FIG. 3A, a selected segment of the GUID content 300 includes cards 305 include a login card 305a, registration cards 305b, 305c, and a login page 305d (collectively card “305”), each of which represent application screens in the run-time environment. The GUID content 300 includes any number of cards designed by the user and/or collaboration team, with each card including any number of graphic elements, including, for example, a set of interaction endpoints 310 (e.g., runtime interactive soft-buttons). For example, the interaction endpoints 310 include a frame, with text content, fill color, line attributes, etc. The interaction endpoints can also include top-level nodes corresponding to individual cards 305a, 305b, 305c, 305d, with each card representing an application screen of the runtime environment.

With further reference to FIG. 3A, the IGDS 100 can provide an interaction trigger feature 338 that is selectable by a design user to generate logical connections between nodal elements of the selected GUID content 300. As described with examples, the user can select a portion of the GUID 300, which in an example shown, corresponds to selection of cards 305a, 305b, 305c, 305d. As shown with FIG. 3B, once the trigger feature 338 is selected, the IGDS 100 automatically determines interactions between the identified endpoint nodes (i.e., cards 305a, 305b, 305c, 305d and interaction endpoints 310).

FIG. 3B illustrates the GUID content 300 as modified to include interactions, as determined by the LCD component 130. As described with examples, the interactions 302 can be generated programmatically in response to a design user selecting the logical connection trigger feature 338 (see FIG. 3A). In examples, each interaction 302 is visually represented by a line connector extending from a start node to a destination node, to represent a state transition of a corresponding functional runtime element. The interactions 302 can thus be programmatically drawn on the canvas on which the GUID content 300 is provided. Depending on implementation, the interactions 302 can be associated with a directional indicator (e.g., arrowhead), representing a sequence between the start node and destination node. Further, each interaction 302 can be generated to include a variety of runtime transition behavior, such as type of input (e.g., on-click, hover). Specific types of runtime transition behavior that can be specified with each interaction 302 can include, for example, (i) navigate from one frame/node to another); (ii) navigate back to a previous card (or screen); (iii) open overlay node, where destination node is opened as an overlay over existing node; (iv) close overlay, to close overlay (i.e., start node) over existing screen (i.e., destination node; and (v) swap overlay, where a current overlay (i.e., start node) is replaced by a new overlay (i.e., destination node).

In examples, the interactions 302 can be visually represented on the GUID content 300. Further, each interaction 302 is inspectable for their respective properties, such as for their respective start node, destination node, runtime transition behavior and/or trigger. The design user can select each interaction 302, and to view and edit the interaction 302 by, for example, changing the source or destination node of the interaction. Alternatively, the user can interact with the interaction 302 to change, for example, the runtime transition behavior and/or trigger, by interacting with an interaction design tool 320.

In an example shown, the IGDS 100 includes an interaction review interface 330 that enables a design user to review/accept interactions 302 in group, or individually. For example, the interaction review interface 330 can include a feature 332 to enable the user to accept all of the programmatically generated interactions 302. The interaction review interface 330 can also include a feature 334 to enable the user to traverse the programmatically-determined interactions 302, and to inspect, review, edit and/or delete such interactions 302. Further, the interaction can generate a summary of the programmatically generated interactions 302.

FIG. 3C and FIG. 3D illustrate an example in which line connectors representing interactions are automatically generated in response to a user input. In FIG. 3C, a selection corresponding to a portion of GUID content 350 is made by a designer, where the selection includes multiple cards 352A-I. The nodes of the cards 352A-I are analyzed to identify interaction nodes that represent interactive features of a runtime environment. For example, the card 352B includes nodes 360, corresponding to interactive soft-buttons for a runtime environment.

With reference to FIG. 3D, the example illustrates a review panel 370 on which line connectors 362 are programmatically generated, where the line connectors representing interactions or runtime transitions. The IGDS 100 may implement an interaction edit mode to provide the interaction review interface 370. As shown, the interactions 362 extend between cards, between interaction nodes and cards (and vice versa), and between interaction nodes of different cards. The line connectors 362 reflecting the interactions can include arrows or other directional indicators to indicate which node of the pairing is the source and the destination. In an example shown, the arrow points to the destination node, to reflect a sequence of the runtime transition. When the interaction review interface 370 is provided (in the interaction edit mode), each of the nodes 360 can be recognized as a single unit, to preclude editing of the nodes. Thus, for example, the user is not able to edit or modify sub-elements (e.g., the frame, fill color, text elements) of the individual nodes 360, but the user can readily use the input to select a line connector that initiates or terminates at the particular node. In this way, when the interaction review interface 370 is provided, the IGDS 100 can interpret user input received at or near the nodes 360 as being input to delete or modify a line connector 362 (representing an interaction) that originates or terminates with the nearby node 360.

In the interaction edit mode, the user can review and confirm (or not) the determined interactions 362 as a group or individually. The user can also view and edit individual interactions 362 (e.g., by changing source and destination node). The user can also interact with the interaction review interface 370 to create new interactions which the IGDS 100 did not identify.

### Network Computer System

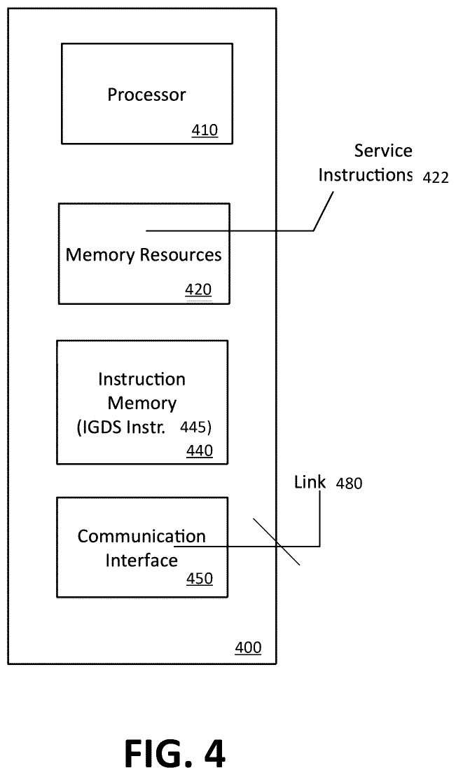

FIG. 4 illustrates a computer system on which one or more embodiments can be implemented. A computer system 400 can be implemented on, for example, a server or combination of servers. For example, the computer system 400 may be implemented as the network computer system 150 in examples of FIG. 1A and FIG. 1B.

In one implementation, the computer system 400 includes processing resources 410, memory resources 420 (e.g., read-only memory (ROM) or random-access memory (RAM)), one or more instruction memory resources 440, and a communication interface 450. The computer system 400 includes at least one processor 410 for processing information stored with the memory resources 420, such as provided by a random-access memory (RAM) or other dynamic storage device, for storing information and instructions which are executable by the processor 410. The memory resources 420 may also be used to store temporary variables or other intermediate information during execution of instructions to be executed by the processor 410.

The communication interface 450 enables the computer system 400 to communicate with one or more user computing devices, over one or more networks (e.g., cellular network) through use of the network link 480 (wireless or a wire). Using the network link 480, the computer system 400 can communicate with one or more computing devices, specialized devices and modules, and/or one or more servers.

In examples, the processor 410 may execute service instructions 422, stored with the memory resources 420, in order to enable the network computing system to implement the UI design platform and operate as the network computer system 150 in examples such as described with examples of FIG. 1A and FIG. 1B. The computer system 400 may also include additional memory resources (“instruction memory 440”) for storing executable instruction sets which are embedded with web pages and other web resources, to enable user computing devices to implement functionality such as described throughout the present disclosure.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

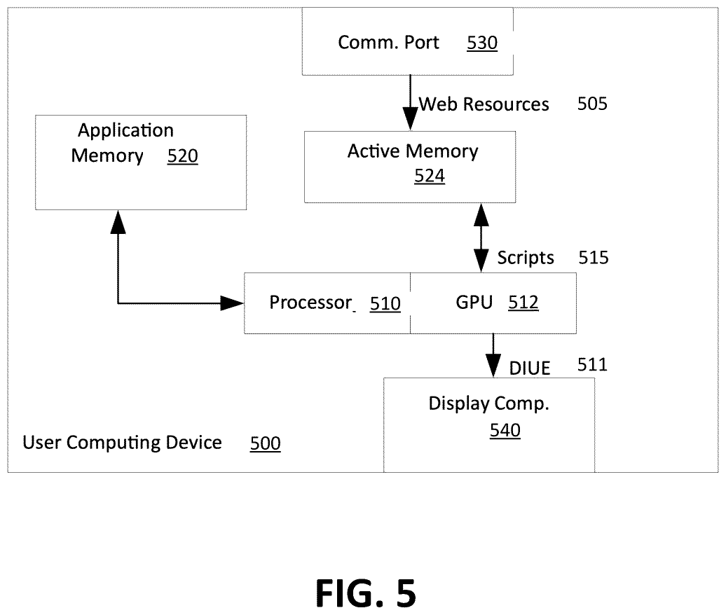

FIG. 5 illustrates a user computing device for use with one or more examples, as described. In examples, a user computing device 500 can correspond to, for example, the user device 10 as shown and described with respect to examples of FIG. 1A and FIG. 1B, and can comprise a smartphone, tablet computer, AR or VR headset, or other touchscreen-based personal computer having graphics processing capabilities that are suitable for enabling renderings of design interfaces and graphic design work.

In examples, the computing device 500 includes a central or main processor 510, a graphics processing unit (GPU) 512, memory resources 520, and one or more communication ports 530. The computing device 500 can use the main processor 510 and the memory resources 520 to store and launch a hybrid web-native collaboration application. In certain examples, a user can operate the application to access a network site of the network collaboration platform, using the communication port 530, where one or more web pages or other web resources 505 for the network collaboration platform can be downloaded. In certain examples, the web resources 505 can be stored in the active memory 524 (cache).

As described by various examples, the processor 510 can detect and execute scripts and other logic which are embedded in the web resources 505 in order to implement the collaborative canvas. In some of the examples, some of the scripts 515 which are embedded with the web resources 505 can include GPU accelerated logic that is executed directly by the GPU 512.

The main processor 510 and the GPU can combine to render a shared content on a display component 540 (e.g., touch-sensitive display device). The rendered design interface can include web content from the web aspect of the hybrid application, as well as design interface content and functional elements generated by scripts and other logic embedded with the web resources 505.

### Example Embodiments

CLAUSE 1. A computer system comprising: a memory sub-system to store a set of instructions; one or more processors that operate to communicate the set of instructions to at least a first user computing device, wherein the set of instructions include instructions that when executed by the first computing device, cause the first computing device to: enabling a user to create and configure graphic user interface content for a runtime environment, the graphic user interface content including a collection of nodes, each node of the collection including node information; receiving input data from the user, the input data identifying at least a portion of the graphic user interface content; determining connection data, as between a set of nodes of the collection, for the identified portion of the graphic user interface content, the connection data being determined based on the node information; and based on the connection data, rendering the portion of the graphic user interface with a set of interactions, each interaction identifying, from the collection, (i) a source node that represents a begin state of a runtime transition, and (ii) a destination node that represents an end state of the runtime transition.

CLAUSE 2. The computing system of clause 1, wherein each interaction includes a directional line connector that extends between the source node and the destination node.

CLAUSE 3. The computing system of clause 1 or 2, wherein each interaction in the set identifies a runtime transition behavior between the begin state and the end state.

CLAUSE 4. The computing system of any of clauses 1-3, wherein the runtime transition behavior includes one of a navigation behavior and/or one or more overlay behaviors.

CLAUSE 5. The computing system of any of clauses 1-4, wherein determining connection data includes generating a request for a model service, the request causing the model service to determine at least some of the connection data.

CLAUSE 6. The computing system of any of clauses 1-5, wherein the model service utilizes an artificial intelligence model.

CLAUSE 7. The computing system of any of clauses 1-6, wherein determining connection data includes analyzing a response from the model service to determine whether any of the determined connection data is invalid.

CLAUSE 8. The computing system of any of clauses 1-7, wherein analyzing the response includes using heuristics and/or rules.

CLAUSE 9. The computing system of any of clauses 1-8, wherein determining at least some of the connection data using at least one of a classifier or heuristics.

CLAUSE 10. The computing system of any of clauses 1-9, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

CLAUSE 11. The computing system of any of clauses 1-10, wherein the node information includes an image of a portion of the graphic user interface content that includes one or more nodes of the collection, including at least one of the source node or the destination node.

CLAUSE 12. The computing system of any of clauses 1-11, wherein the input data identifies a portion of the graphic user interface content that includes at least one of the source node or the destination node.

CLAUSE 13. A computer-implemented method for operating a computing device, the method comprising: enabling a user to create and configure graphic user interface content for a runtime environment, the graphic user interface content including a collection of nodes, each node of the collection including node information; receiving input data from the user, the input data identifying at least a portion of the graphic user interface content; determining connection data, as between a set of nodes of the collection, for the identified portion of the graphic user interface content, the connection data being determined based on the node information; and based on the connection data, rendering the portion of the graphic user interface with a set of interactions, each interaction identifying, from the collection, (i) a source node that represents a begin state of a runtime transition, and (ii) a destination node that represents an end state of the runtime transition.

CLAUSE 14. The method of clause 13, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

CLAUSE 15. The method of clause 13 or 14, wherein the node information includes an image of a portion of the graphic user interface content that includes one or more nodes of the collection, including at least one of the source node or the destination node.

CLAUSE 16. The method of any of clauses 13-15, wherein the input data identifies a portion of the graphic user interface content that includes at least one of the source node or the destination node.

CLAUSE 17. A non-transitory computer-readable medium comprising instructions, which when executed by one or more processors of a computer system, cause the computer system to perform operations that include: enabling a user to create and configure graphic user interface content for a runtime environment, the graphic user interface content including a collection of nodes, each node of the collection including node information; receiving input data from the user, the input data identifying at least a portion of the graphic user interface content; determining connection data, as between a set of nodes of the collection, for the identified portion of the graphic user interface content, the connection data being determined based on the node information; and based on the connection data, rendering the portion of the graphic user interface with a set of interactions, each interaction identifying, from the collection, (i) a source node that represents a begin state of a runtime transition, and (ii) a destination node that represents an end state of the runtime transition.

CLAUSE 18. The non-transitory computer-readable medium of clause 17, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

CLAUSE 19. The non-transitory computer-readable medium of clause 17 or 18, wherein the node information includes an image of a portion of the graphic user interface content that includes one or more nodes of the collection, including at least one of the source node or the destination node.

CLAUSE 20. The non-transitory computer-readable medium any of clauses 17-19, wherein the input data identifies a portion of the graphic user interface content that includes at least one of the source node or the destination node.

CLAUSE 21. A network computer system comprising: one or more processors; a memory to store instructions; wherein the one or more processors execute the instructions to perform operations that include: enabling a user to create and configure graphic user interface content for a runtime environment, the graphic user interface content including a collection of nodes, each node of the collection including node information; receiving input data from the user, the input data identifying at least a portion of the graphic user interface content; determining connection data, as between a set of nodes of the collection, for the identified portion of the graphic user interface content, the connection data being determined based on the node information; and based on the connection data, rendering the portion of the graphic user interface with a set of interactions, each interaction identifying, from the collection, (i) a source node that represents a begin state of a runtime transition, and (ii) a destination node that represents an end state of the runtime transition.

CLAUSE 22. The network computer system of clause 21, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

CLAUSE 23. The network computer system of clause 21 or 22, wherein the node information includes an image of a portion of the graphic user interface content that includes one or more nodes of the collection, including at least one of the source node or the destination node.

CLAUSE 24. The network computer system of any of clauses 21-23, wherein the input data identifies a portion of the graphic user interface content that includes at least one of the source node or the destination node.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer system comprising:
a memory sub-system to store a set of instructions;
one or more processors that operate to communicate the set of instructions to at least a first user computing device, wherein the set of instructions include instructions that when executed by the first computing device, cause the first computing device to:
enabling a user to create and configure graphic user interface content for a runtime environment, the graphic user interface content including a collection of nodes, each node of the collection including node information;
receiving input data from the user, the input data identifying at least a portion of the graphic user interface content;
determining connection data, as between a set of nodes of the collection, for the identified portion of the graphic user interface content, the connection data being determined based on the node information; and
based on the connection data, rendering the portion of the graphic user interface with a set of interactions, each interaction identifying, from the collection, (i) a source node that represents a begin state of a runtime transition, and (ii) a destination node that represents an end state of the runtime transition.

2. The computing system of claim 1, wherein each interaction includes a directional line connector that extends between the source node and the destination node.

3. The computing system of claim 1, wherein each interaction in the set identifies a runtime transition behavior between the begin state and the end state.

4. The computing system of claim 3, wherein the runtime transition behavior includes one of a navigation behavior and/or one or more overlay behaviors.

5. The computing system of claim 1, wherein determining connection data includes generating a request for a model service, the request causing the model service to determine at least some of the connection data.

6. The computing system of claim 5, wherein the model service utilizes an artificial intelligence model.

7. The computing system of claim 6, wherein determining connection data includes analyzing a response from the model service to determine whether any of the determined connection data is invalid.

8. The computing system of claim 7, wherein analyzing the response includes using heuristics and/or rules.

9. The computing system of claim 1, wherein determining at least some of the connection data using at least one of a classifier or heuristics.

10. The computing system of claim 1, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

11. The computing system of claim 1, wherein the node information includes an image of a portion of the graphic user interface content that includes one or more nodes of the collection, including at least one of the source node or the destination node.

12. The computing system of claim 1, wherein the input data identifies a portion of the graphic user interface content that includes at least one of the source node or the destination node.

13. A computer-implemented method for operating a computing device, the method comprising:
enabling a user to create and configure graphic user interface content for a runtime environment, the graphic user interface content including a collection of nodes, each node of the collection including node information;
receiving input data from the user, the input data identifying at least a portion of the graphic user interface content;
determining connection data, as between a set of nodes of the collection, for the identified portion of the graphic user interface content, the connection data being determined based on the node information; and
based on the connection data, rendering the portion of the graphic user interface with a set of interactions, each interaction identifying, from the collection, (i) a source node that represents a begin state of a runtime transition, and (ii) a destination node that represents an end state of the runtime transition.

14. The method of claim 13, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

15. The method of claim 13, wherein the node information includes an image of a portion of the graphic user interface content that includes one or more nodes of the collection, including at least one of the source node or the destination node.

16. The method of claim 13, wherein the input data identifies a portion of the graphic user interface content that includes at least one of the source node or the destination node.

17. A non-transitory computer-readable medium comprising instructions, which when executed by one or more processors of a computer system, cause the computer system to perform operations that include:
enabling a user to create and configure graphic user interface content for a runtime environment, the graphic user interface content including a collection of nodes, each node of the collection including node information;
receiving input data from the user, the input data identifying at least a portion of the graphic user interface content;
determining connection data, as between a set of nodes of the collection, for the identified portion of the graphic user interface content, the connection data being determined based on the node information; and
based on the connection data, rendering the portion of the graphic user interface with a set of interactions, each interaction identifying, from the collection, (i) a source node that represents a begin state of a runtime transition, and (ii) a destination node that represents an end state of the runtime transition.

18. The non-transitory computer-readable medium of claim 17, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

19. The non-transitory computer-readable medium of claim 17, wherein the node information includes an image of a portion of the graphic user interface content that includes one or more nodes of the collection, including at least one of the source node or the destination node.

20. The non-transitory computer-readable medium of claim 17, wherein the input data identifies a portion of the graphic user interface content that includes at least one of the source node or the destination node.

21. A network computer system comprising:
one or more processors;
a memory to store instructions;
wherein the one or more processors execute the instructions to perform operations that include:
enabling a user to create and configure graphic user interface content for a runtime environment, the graphic user interface content including a collection of nodes, each node of the collection including node information;
receiving input data from the user, the input data identifying at least a portion of the graphic user interface content;
determining connection data, as between a set of nodes of the collection, for the identified portion of the graphic user interface content, the connection data being determined based on the node information; and
based on the connection data, rendering the portion of the graphic user interface with a set of interactions, each interaction identifying, from the collection, (i) a source node that represents a begin state of a runtime transition, and (ii) a destination node that represents an end state of the runtime transition.

22. The network computer system of claim 21, wherein for each node of the collection, the node information includes one or more of (i) a node identifier or name; (ii) a text attribute; (iii) a hierarchical relationship of the node with another node; (iv) a logical relationship as between the node and another node; and/or (v) a position of the node relative to another node of the collection.

23. The network computer system of claim 21, wherein the node information includes an image of a portion of the graphic user interface content that includes one or more nodes of the collection, including at least one of the source node or the destination node.

24. The network computer system of claim 21, wherein the input data identifies a portion of the graphic user interface content that includes at least one of the source node or the destination node.
